(19) United States
(12) Patent Application Publication
(10) Pub. No.: US 2006/0107841 A1
(43) Pub. Date: May 25, 2006

(54) Beverage machine for preparing a hot beverage by brewing and extracting a substance received in a cartridge

(76) Inventor: Rene Schifferle, Doettingen (CH)

Correspondence Address: MAGINOT, MOORE & BECK, LLP;CHASE TOWER, 111 MONUMENT CIRCLE, SUITE 3250, INDIANAPOLIS, IN, 46204, US

(21) Appl. No.: 11/267,118

(22) Filed: Nov. 4, 2005

(30) Foreign Application Priority Data
Nov. 22, 2004 (DE) 10 2004 056 317.9

(51) Int. Cl. A47J 31/00

(52) U.S. Cl. 99/279

(57) ABSTRACT

The beverage machine for preparing a hot beverage by brewing and extracting a substance received in a cartridge is provided with a brewing chamber comprising a lower brewing chamber portion and a closure element. The lower portion of the brewing chamber serves for positively receiving of the cartridge. On both the lower brewing chamber portion and the closure element, piercing elements are provided for piercing the cartridge at opposite sides thereof. Upon closing the brewing chamber, the lower portion thereof, together with the cartridge received therein, is axially moved relative to the closure member to such an extent that the cover of the cartridge is pierced by means of the one piercing member. The bottom of the cartridge is pierced by the other piercing member only to such an extent that the tip of the piercing member penetrates the bottom of the cartridge, without a beverage outlet channel provided in the other piercing element being connected to the interior of the cartridge.

### BACKGROUND OF THE INVENTION

The present invention refers to a beverage machine for preparing a hot beverage by brewing and extracting a substance received in a cartridge. Further, the invention also refers to a cartridge to be used in a beverage machine, and finally, the invention refers to a method of preparing a hot beverage by brewing and extracting a substance received in a cartridge.

Cartridges of the kind referred to herein serve for receiving a hermetically sealed substance suitable for preparing a hot beverage. A fundamental advantage of such cartridges consists in the fact that the substance contained therein, for example coffee powder, can be kept fresh during an extended period of time. For extracting coffee powder contained in such a cartridge, for example, semi-automatic espresso coffee makers are used in which the cartridge is inserted into a cartridge holder with the cover of the cartridge downwards.

### PRIOR ART

The document EP-A-0,512,470 discloses such a coffee maker in which the cartridge is inserted into a cartridge holder with the cover downwards. The cartridge holder is manually inserted into the coffee maker by means of a bayonet fixture. The coffee maker is provided with a piercing member located in the region of the connecting means for the cartridge holder. The piercing member has radial outlet openings for feeding brewing water into the cartridge. Upon connecting the cartridge holder to the coffee maker, the piercing member pierces the bottom of the cartridge. The bottom of the cartridge holder itself is provided with a plurality of embossments arranged on a grating. These embossments penetrate the cover of the cartridge and break it open as soon as the brewing water fed into the interior of the cartridge has built up a certain overpressure. During the subsequent brewing operation, the brewing water is fed into the cartridge through the piercing member, flows under pressure through the coffee powder and is discharged through the apertures in the cover. The freshly brewed coffee beverage can flow out through the grating and leave the coffee maker through outlet means located below the cartridge holder.

The document DE-C-41,92,762 discloses an apparatus for preparing a liquid product by feeding a fluid and/or steam into a cartridge. The apparatus is provided with a withdrawal member, comprising a chamber for a cartridge. The cartridge has a bottom portion concavely curved towards its interior. At the apparatus, a piercing pin provided with fluid channels is provided, while the bottom of the withdrawal member comprises a plurality of embossments causing a perforation of the bottom of the cartridge as soon as the cartridge is sufficiently deformed under the influence of the pressure of the brewing water. In an alternative embodiment, the bottom of the withdrawal member comprises a single piercing pin, having an integrated liquid discharge channel. By providing the cartridge with a concavely shaped bottom, it is to be realized that the bottom is pierced only when the bottom of the cartridge is deformed to a certain degree and the interior volume of the cartridge has been increased. Thereby, it should be ensured that the brewing water fed into the interior of the cartridge can soak the substance received in the cartridge before the bottom of the cartridge is broken open to have the prepared beverage flow out.

The document EP-A-1,295,554 discloses a coffee maker for brewing coffee powder packed into a cartridge. The coffee maker is provided with a pressurized hot water sprinkler and with a dispensing cup movable relative thereto. The dispensing cup is provided with an open hollow space, i.e. a brewing chamber, as well as with a second space, communicating with a perculator spout for dispensing the brewed coffee beverage. Between the hollow space for receiving the cartridge and the second space, a plate is provided whose top side has a plurality of needles. Each of these needles has a conical outer surface as well as several slots, each of the slots communicating via an aperture in the plate with the second space. The hot water sprinkler is provided with a cup-shaped front portion that is axially movable against the force of a number of springs. At the rigid back portion of the hot water sprinkler, a piercing element in the form of a plate having a plurality of needles is provided. The cup-shaped front portion is provided with an end wall, having a number of holes, through which the needles can extend when the cup-shaped front portion is in its operating position, in order to pierce the top of the cartridge. To axially move the dispensing cup relative to the hot water sprinkler, a not further shown drive means is provided. When the dispensing cup is moved towards the hot water sprinkler, the top of the cartridge is pierced by the needles provided on the hot water sprinkler, while the bottom of the cartridge remains intact because the needles on the plate have a length that is approximately equal to, but not greater than the distance between an annular shoulder at the bottom of the hollow space and an annular groove, serving to receive the above mentioned plate. The height of the needles on the plate between the hollow space and the second space, thereby, is chosen such that the needles at the most touch the bottom of the cartridge, but do not weaken it or even pierce it when the brewing chamber is closed. The brewing water having fed into the interior of the cartridge, the bottom thereof is deformed outwards under the influence of the heat and the pressure such that the needles penetrate the bottom of the cartridge and gradually pierce it.

The document EP-A-1,101,430 discloses a cartridge for a beverage filter cartridge system. The side wall of this cartridge is provided with several steps for supporting a filter member or a porous membrane, such that a free space remains between the filter element and the membrane, respectively, and the cartridge cover and cartridge bottom, respectively. This free space is used for inserting an inlet pipe and an outlet pipe, respectively, through the side wall into the cartridge.

The document WO 00/42891 discloses an automatic brewing system fro brewing substances received in a cartridge. The brewing system is provided with a liquid supply tank and a dosage chamber located therein, the dosage chamber being operatively connected to an air pump for conveying a certain amount of liquid. The system further comprises a cartridge holder, cooperating with a movable cover. Both the cover and the bottom of the cartridge holder are equipped with a hollow piercing member. If the cartridge holder is closed by means of the cover, both the cartridge cover and the cartridge bottom are pierced by means of the respective piercing elements. The piercing element located at the bottom of the cartridge holder is designed such that an outlet for the prepared beverage is created as soon as the bottom of the cartridge is pierced.

### OBJECTS OF THE INVENTION

It is an object of the present invention to provide a beverage machine for preparing a hot beverage by brewing and extracting a substance received in a cartridge in which the cartridge is broken open and pierced, respectively, to form a beverage outlet only at a predetermined moment and at a predetermined location.

It is a further object of the present invention to provide a beverage machine for preparing a hot beverage by brewing and extracting a substance received in a cartridge in which the contamination of the machine by the extract leaving the cartridge in liquid form should be reduced.

It is a further object of the present invention to provide a beverage machine for preparing a hot beverage by brewing and extracting a substance received in a cartridge in which the pressure of the brewing water required to break open an outlet in the cartridge is reduced.

### SUMMARY OF THE INVENTION

To meet these and other objects, the present invention provides, according to a first aspect, a beverage machine for preparing a hot beverage by brewing and extracting a substance received in a cartridge having a cartridge cover and a cartridge bottom portion. The beverage machine comprises a brewing chamber adapted to receive the cartridge with a lower brewing chamber portion and a closure element, a pump for feeding brewing water under pressure into the brewing chamber, and at least one first piercing member adapted to pierce the cartridge cover.

Further, the machine comprises, for piercing the cartridge bottom portion, at least one second piercing member comprising at least one piercing tip portion and at least one outlet channel. Thereby, means are provided for axially moving the lower brewing chamber portion relative to the closure element for closing the brewing chamber. The length of the path of the axial movement of the lower brewing chamber portion relative to the closure element is such that the cartridge cover is pierced by the first piercing element, while the second piercing element penetrates or pierces the cartridge bottom at the most to such an extent that the outlet channel of the second piercing element does not communicate with the interior of the cartridge.

Due to the fact, upon closing the brewing chamber, that the lower portion of the brewing chamber, together with the cartridge received therein, is axially moved relative to the closure element to such an extent that the tip of the second piercing member penetrates the bottom of the cartridge at the most only to such a degree that the outlet channel does not yet communicate with the interior of the cartridge, it can be ensured that the bottom of the cartridge is fully pierced, upon feeding pressurized brewing water into the cartridge, at a relatively low pressure level of the brewing water and at a predetermined location, whereby, simultaneously, the danger of contamination is substantially reduced, because the piercing of the bottom of the cartridge is performed in a continuous manner.

If the bottom of the cartridge, upon closing the brewing chamber, is pierced by the piercing member located on the lower portion of the brewing chamber only to such an extent that the outlet channel does not communicate with the interior of the cartridge, it also can be ensured that any gaseous medium usually present in the interior of the cartridge can escape during feeding brewing water into the cartridge to evenly soak the substance received in the cartridge, whereby simultaneously a certain overpressure can be built up in the interior of the cartridge before the liquid extract is discharged from the cartridge.

According to a further aspect, the invention provides a beverage machine for preparing a hot beverage by brewing and extracting a substance received in a cartridge having a cartridge cover and a cartridge bottom portion. The brewing machine comprises a brewing chamber adapted to receive the cartridge for brewing and extracting the substance contained in the cartridge with a lower brewing chamber portion and a closure element, a pump for feeding brewing water under pressure into the brewing chamber, at least one first piercing member adapted to pierce the cartridge cover and attached to the closure element, and at least one second piercing member adapted to pierce the cartridge bottom portion and attached to or located in the region of the lower brewing chamber portion.

Means are provided for axially moving the second piercing member attached to or located in the region of the lower brewing chamber portion relative to the lower brewing chamber portion to such an extent, after the brewing chamber having been closed by the closure member, that the bottom of the cartridge is pierced. In this way, the bottom of the cartridge can be pierced independently of the closing operation of the brewing chamber and independently of the moment of feeding brewing water into the cartridge.

According to a still further aspect, the invention also provides a cartridge adapted to be used in such a beverage machine. It comprises an essentially cup-shaped cartridge body and a cartridge cover attached to the cartridge body. The cartridge contains a predetermined amount of a substance extractable by means of hot water. At least one sieve-like member is located between the bottom of the cartridge body and the substance contained in the cartridge. The sieve-like member has a central recess directed towards the interior of the cartridge and dimensioned such that the front portion of a piercing member adapted to pierce the bottom of the cartridge body can extend into the recess, once the cartridge bottom has been pierced, without piercing the first sieve-like member.

A second sieve-like member can be located between the cover of the cartridge body and the substance contained in the cartridge, also having a central recess directed towards the interior of the cartridge and dimensioned such that the front portion of a piercing member adapted to pierce the cover of the cartridge can extend into the recess, once the cartridge cover has been pierced, without piercing the second sieve-like member.

According to a final aspect, the invention also provides a method of preparing a hot beverage by brewing and extracting a substance received in a cartridge. In this method, the cartridge is placed into a brewing chamber and a first side of the cartridge is pierced by means of a first piercing member. Then, the cartridge is weakened or partially pierced at the opposite side of the cartridge by means of a second piercing member to such an extent that a beverage outlet channel of the second piercing element is not yet connected to the interior of the cartridge. Finally, brewing water is fed through a brewing water feed channel of the first piercing member into the interior of the cartridge to create a hydraulic overpressure in the interior of the cartridge, thereby expanding the cartridge such that it is fully pierced by the second piercing member at the opposite side to connect the interior of the cartridge to the beverage outlet channel in the second piercing member.

### BRIEF DESCRIPTION OF THE DRAWINGS

In the following, embodiments of the invention will be further described, with reference to the accompanying drawings, in which:

FIG. 1 shows a strictly schematic view of the beverage machine according to the invention, together with a cartridge, in a partially sectioned view;

FIG. 1a shows an enlarged view of the lower piercing member;

FIG. 2 shows a longitudinal sectional view of the brewing chamber and of the cartridge in a first phase during the closing of the brewing chamber;

FIG. 3 shows a longitudinal sectional view of the closed brewing chamber and of the cartridge before brewing water is injected into the brewing chamber;

FIG. 4 shows a longitudinal sectional view of the closed brewing chamber and of the cartridge during the injection of brewing water into the brewing chamber; and

FIG. 5 shows a longitudinal sectional view of the closed brewing chamber and of the cartridge according to an alternative embodiment of the invention.

### DETAILED DESCRIPTION OF THE PREFERRED EMBODIMENTS

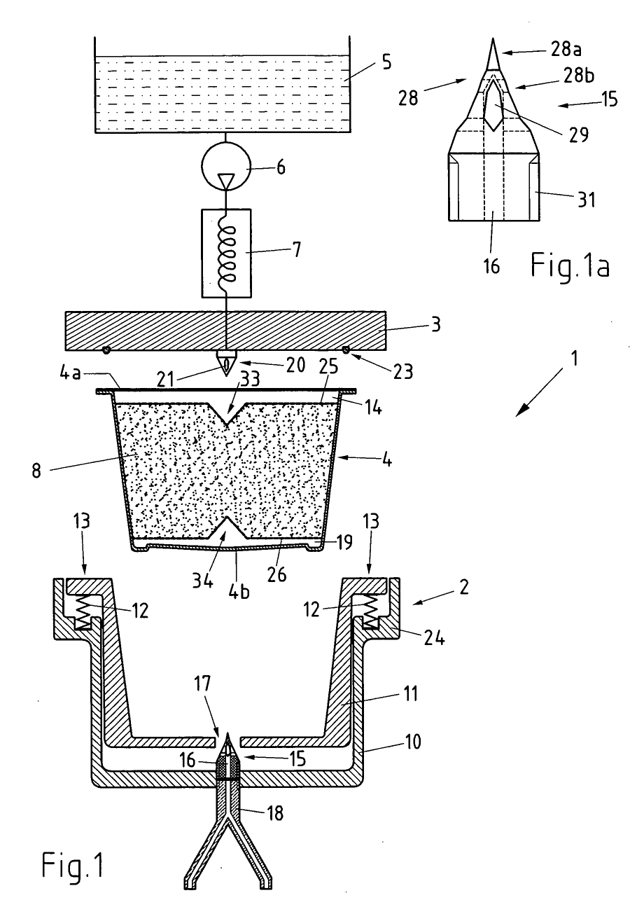

FIG. 1 shows a strictly schematic view of an embodiment of a beverage machine, designed in the present example as a coffee maker. Particularly, shown in FIG. 1 are a brewing chamber 1, a fresh water tank 5, a pump 6 as well as a boiler 7. The brewing chamber 1, shown in a longitudinal sectional view, comprises a lower portion 2 and a closure element 3. Also shown in FIG. 1 in a schematic longitudinal sectional view is a cartridge 4 containing ground coffee 8.

The means for fixing the lower portion 2 of the brewing chamber 1 to the coffee maker and to the closure element 3, respectively, are not shown in the drawings. Neither shown are the means required for realizing the axial relative movement between the lower portion 2 of the brewing chamber 1 and the closure element 3 for closing the brewing chamber.

The lower portion 2 of the brewing chamber 1 comprises an outer base portion 10 and an inner cartridge receptacle 11. Both the base portion 10 and the cartridge receptacle 11 have essentially circular shape. The cartridge receptacle 11 is adapted to receive the cartridge 4 in a positively fitting manner and supported on the outer base portion 10 by means of springs 12. The top portion of the cartridge receptacle 11 facing the closure member 3 is provided with an annular shoulder 13. The outer base portion 10 is provided with an annular flange 24, constituting, together with the shoulder 13 of the cartridge receptacle 11, an axial limit stop during closing the brewing chamber 1.

The bottom of the outer base portion 10 is provided with a piercing member 15, having a central outlet channel 16. The piercing member 15 can extend into the interior of the cartridge receptacle 11 through an opening 17 provided in the bottom of the cartridge receptacle 11. Below the bottom of the base portion 10, a Y-shaped beverage outlet 18 is located, communicating with the central outlet channel 16 of the piercing member 15. The cartridge receptacle 11 simultaneously serves as a finger guard inasmuch as it prevents access to the piercing member 15 as long as the coffee maker is in its rest position as shown in FIG. 1.

The bottom of the closure member 3 facing the lower portion 2 of the brewing chamber 1 is provided with a piercing member 20, too. Through this piercing member 20, the brewing water required for brewing and extracting the coffee powder 8 is fed into the interior of the cartridge 4. To this end, the piercing member 20 is provided with radial outlet openings 21 through which the brewing water can escape from the piercing member 20. The closure member 3 comprises an annular gasket 23 radially surrounding the piercing member 20 and serving for sealing the top portion of the cartridge 4 with regard the lower portion of the cartridge 4.

The cartridge 4 comprises a cup-shaped lower portion and a cover 4a welded thereto. Both the cup-shaped lower portion and the cover 4a are made of an oxygen impermeable multi layer foil of plastic material, whereby particularly the foil constituting the cup-shaped lower portion of the cartridge 4 should be elastic.

Even if such a cartridge 4 is suitable to receive any substance extractable by means of water, in the following, it is assumed that it is filled with ground coffee, i.e. coffee powder, adapted to be used to prepare a regular coffee or an espresso coffee beverage.

Preferably, the bottom 4b is slightly bossed, i.e. it is curved to the outside to a convex shape. Moreover, the cartridge 4 is preferably provided with an upper sieve-like member 25 and with a lower sieve-like member 26. Thereby, the upper member 25 serves as a distribution sieve member and the lower member 26 as a collection sieve member. The two sieve members 25, 26 are provided with a plurality of apertures through which the brewing water can be fed into the interior of the cartridge 4, and the coffee beverage can escape from the interior of the cartridge 4 filled with coffee powder, respectively. Both sieve members 25, 26 comprise each a central recess 33, 34 directed to the interior of the cartridge 4 into which the corresponding piercing members 15, 20 can extend after the cover 4a of the cartridge 4 and the bottom 4b thereof, respectively, have been pierced, without damaging the sieve members 25, 26.

The coffee powder 8 to be extracted is received between the two sieve members 25, 26. The two rigidly designed sieve members 25, 26 serve to ensure, on the one hand, that the coffee powder cannot escape the cartridge 4 once its cover 4a and its bottom 4b, respectively, have been pierced. On the other hand, the upper distribution sieve member 25 serves to evenly distribute the brewing water entering the cartridge 4 over the entire cross section of the cartridge 4, while the lower collection sieve member 26 serves to ensure that the liquid coffee extract flows to the central piercing member 15. To this end, both at the top and the bottom, free spaces 14, 19 are provided between the upper distribution sieve member 25 and the cartridge cover 4a, and between the lower collection sieve member 26 and the cartridge bottom 4b, respectively. Instead of the free spaces 14, 19 shown in the drawings, the sieve members 25, 26 could also be provided with recesses in the shape of channels in which the brewing water flows to be distributed over the cross section of the cartridge 4, and in which the extracted beverage flows to be collected, respectively. In this case, the sieve members 25, 26 can be directly supported by the cover 4a of the cartridge 4 and the bottom 4b of the cartridge, respectively, on the raised portions extending between the channels.

FIG. 1a shows an enlarged side view of the piercing member 15. The piercing member 15 is provided with a two-tiered tip 28, whereby the first portion 28a has conical shape having a smooth jacket surface and ending in an acute tip end, while the second portion 28b has the shape of a truncated cone with a larger cone angle and is provided with several radial apertures 29, opening into the central outlet channel 16. The lower portion of the piercing member 15 is provided with a thread 31 by means of which it can be screwed into the bottom of the lower portion 2 of the brewing chamber 1. Instead of radial apertures 29, the second portion 28b can be provided, for example, with axially extending outlet grooves, channels or the like. Moreover, instead of the thread 31, for example a push-fit connection can be provided for attaching the piercing member 15 to the bottom of the lower portion 2 of the brewing chamber 1. In any case, the outlet channel and the radial outlet openings 29, respectively, are located behind or, as seen in the drawing, below the tip 28.

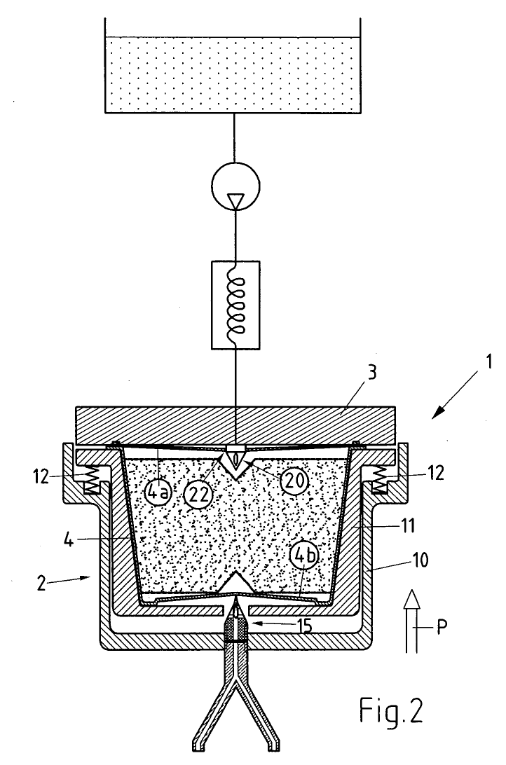

FIG. 2 shows a longitudinal sectional view of the brewing chamber 1 and the cartridge 4 in a first phase during closing the brewing chamber 1. The cartridge 4 having been inserted into the cartridge receptacle 11, the lower portion 2 of the brewing chamber 1 is axially moved upwards, in the direction of the arrow P, towards the closure member 3. Thereby, the cartridge receptacle 11 is pushed into the outer base portion 10 of the lower portion 2 of the brewing chamber 1 against the force of the springs 12. Simultaneously, the upper piercing member 20 penetrates the cover 4a of the cartridge 4, while the lower piercing member 15 abuts against the bottom 4b of the cartridge 4 and pushes the bottom 4b upwards, with the result that the cartridge bottom 4b is deformed towards the cartridge cover 4a and the internal volume of the cartridge 4 is decreased. Due to the fact that the cup-shaped lower portion of the cartridge 4 is made of an elastic material and that the cartridge bottom 4b is bossed, the cartridge bottom 4b can be relatively easily deflected in a direction towards the cartridge cover 4a.

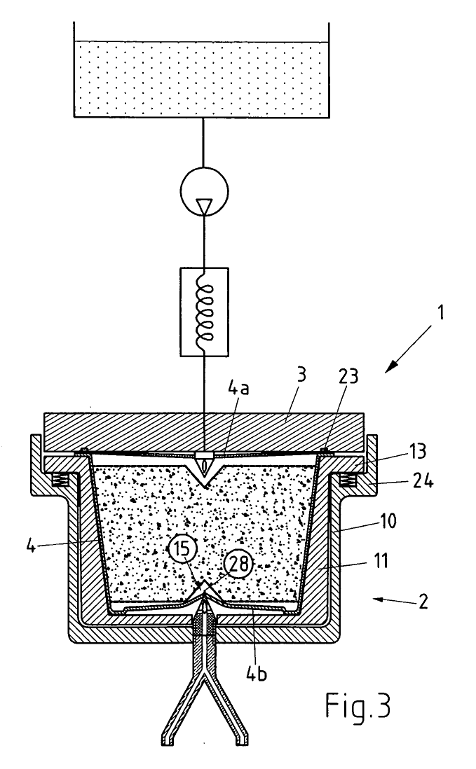

FIG. 3 shows a longitudinal sectional view of the closed brewing chamber 1 and the cartridge 4 before brewing water is injected into the cartridge 4. The closed state of the brewing chamber 1 is realized by mechanically moving the lower portion 2 of the brewing chamber 1 upwards to such an extent that the shoulder 13 of the cartridge receptacle 11 rests against the flange 24 of the outer base portion 10. Simultaneously, the cartridge cover 4a is hydraulically sealed with reference to the cartridge bottom 4b at the outside, due to the fact that the gasket 23 provided at the bottom of the closure element 3 is pressed against the top of the cartridge cover 4a to seal it radially against the outside. Further, it can be seen in FIG. 3 that the tip 28 of the piercing member 15 provided at the bottom of the lower portion 2 of the brewing chamber 1, particularly its first portion 28a (FIG. 1a), penetrates the bottom 4b of the cartridge 4. Due to the fact that the first portion 28a has an acuter angle than the second portion 28b, the result is that the cartridge bottom 4b rests against the second portion 28b and keeps this position once the brewing chamber 1 is closed, but before brewing water is injected into the cartridge 4.

Because the cartridge bottom 4b rests against the second portion 28b of the piercing member 15, it can be ensured that the radial apertures 29 and the outlet channel 16, respectively, do not yet communicate with the interior of the cartridge 4, even if the cartridge bottom 4b is already perforated. Instead of the here shown perforating of the cartridge bottom 4b by the tip 28 of the piercing member 15, it may be sufficient to partially weaken the cartridge bottom 4b by means of the tip 28, but without the tip 28 really perforating the bottom 4b. In any case, the cartridge cover 4a is made of a material having a lower extensibility and/or a lower tear strength than the material of which the cartridge bottom 4b is made, to ensure that the upper piercing member 20 perforates the cartridge cover 4a, while the cartridge bottom 4b is perforated at the most by the tip 28 of the relating piercing member 15.

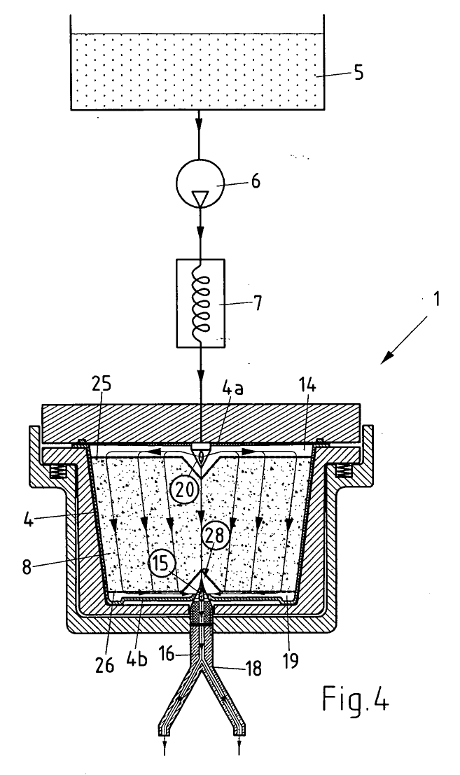

FIG. 4 shows the so-called brewing and extracting phase in a view similar to the view in FIG. 3. In this phase, water is fed from the fresh water tank 5 into the boiler 7 by means of the pump 6. In the boiler 7, the water is heated to the required brewing temperature. The heated and pressurized water is led via the upper piercing member 20 into the space 14 between the cover 4a and the upper distribution sieve member 25, where it is evenly distributed over the cross section of the cartridge 4. Through the openings provided in the upper distribution sieve member 25, the brewing water enters the interior of the cartridge 4 and extracts the coffee powder. Through the openings provided in the lower collection sieve member 26, the liquid coffee extract flows into the space 19 between the lower collection sieve member 26 and the cartridge bottom 4b. Since the cartridge 4 is positively surrounded by the cartridge receptacle 11, the overpressure generated by injecting pressurized water into the cartridge 4 has the effect that the cartridge cover 4a is pressed against the bottom of the closure member 3 and that the cartridge bottom 4b is deflected downwards such that the internal volume substantially reaches its former value. During the injection of brewing water into the cartridge 4, any gas present in the interior of the cartridge 4 can escape through the radial gap between piercing tip 28 and cartridge bottom 4b, thus ensuring an even moistening of the coffee powder 8 received in the cartridge 4. By pressing the cartridge bottom 4b downwards, as herein before described, the opening in the bottom 4b of the cartridge 4 is increased to such an extent that the radial apertures 29 and, thereby, the outlet channel 16 communicate with the interior of the cartridge 4. Now, the liquid coffee extract can flow from the lower space 19 through the radial apertures 29 in the piercing member 15 into the outlet channel 16 and, there from, into the beverage outlet 18, from where it can be dispensed into a not further shown beverage container.

The mechanical weakening and piercing of the cartridge bottom 4b, respectively, as previously described, brings along a number of substantial advantages:
The cartridge bottom 4b is weakened or pierced at a pre-determined location in a well defined manner.
After brewing water has been injected into the cartridge, a continuous enlargement of the pierced opening in the cartridge bottom takes place by gradually generating a hydraulic overpressure in the interior of the cartridge such that the cartridge bottom is pressed and deflected downwards towards the piercing member. Thus, the liquid coffee extract can smoothly flow out downwards through the continuously enlarging outlet cross section in the lower piercing member, since its radial apertures are continuously more and more exposed during pressing the cartridge bottom downwards. The result is, on the one hand, that the danger of contamination is reduced because the liquid coffee extract cannot suddenly escape from the cartridge as is the case with a cartridge that is pierced only under the influence of the pressurized brewing water. On the other hand, the gaseous medium contained in the cartridge, for example air and/or CO₂, can escape downwards through the narrow radial gap between piercing tip and cartridge bottom once brewing water is injected into the cartridge from the top thereof. The result is that the ground coffee contained in the cartridge is homogenously moistened over the entire cross section of the cartridge once the brewing water flows into the cartridge from its top.
The brewing water pressure required for piercing the cartridge bottom and for enlarging the pierced opening, respectively, is comparatively low.
The brewing water pressure required for piercing the cartridge bottom and for enlarging the pierced opening, respectively, can be more exactly calculated.
The cartridge may show higher manufacturing tolerances with regards of its dimensions without the danger that the brewing operation would be impaired.
The bottom of the cartridge has not to be rigid and needs not to have a concave basic shape.
The danger of breaking open the cartridge at an undesired location under the influence of the required high hydraulic overpressure of up to 10 bar is practically eliminated.

Instead of perforating the bottom of the cartridge by means of the lower piercing member, alternatively, the design could be such that the bottom 4b is only weakened by the lower piercing member 15 upon mechanically closing the brewing chamber 1, without the lower piercing member 15 penetrating the bottom 4b of the cartridge 4. In any case, even by means of a mechanical weakening, it can be ensured that the bottom of the cartridge is continuously broken open at a well defined location even-if the brewing water is injected into the cartridge with a relatively low pressure. Indpependently there from, the lower piercing member 15 could be provided with a pressure control valve, opening only after a certain overpressure is reached to release the outlet channel 16.

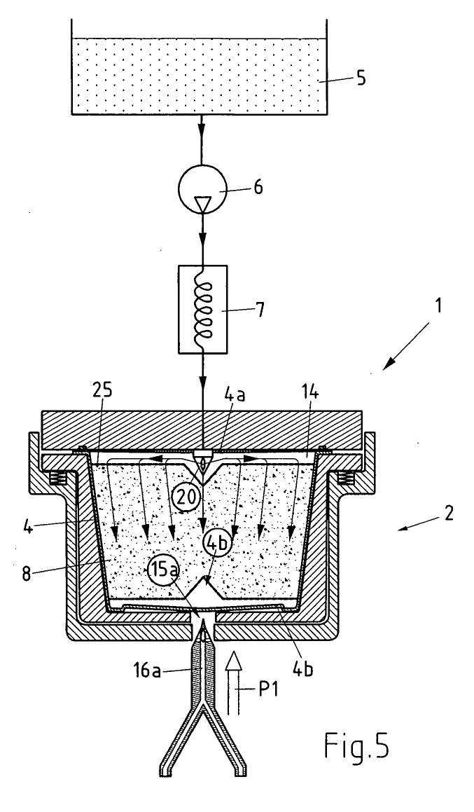

FIG. 5 shows an alternative embodiment in a view similar to FIG. 4. In this embodiment, the lower piercing member 15a is not fixedly attached to the lower portion 2 of the brewing chamber 1, but axially movable in the direction of the arrow P1 and relative to the lower portion 2 of the brewing chamber 1. The means required to move the piercing member 15a are not shown. This embodiment shows the advantage that the moment in which the bottom 4b of the cartridge 4 is pierced can be arbitrarily chosen, independently of the closing operation of the brewing chamber and of the hydraulic pressure existing in the interior of the cartridge. Preferably, the cartridge bottom 4b is pierced shortly after the brewing water has been injected into the top of the cartridge 4. Also in this case, the piercing operation can be performed in two steps. In other words, in a first step, the cartridge bottom 4b is pierced to such an extent that the outlet channel 16a in the interior of the piercing element 15 does not yet communicate with the interior of the cartridge 4; thus, the gas contained in the interior of the cartridge 4 can escape. In a second step, the piercing member 15a is pushed further into the cartridge bottom 4b until the radial apertures and the outlet channel 16a of the piercing member 15a communicate with the interior of the cartridge such that the liquid coffee extract can flow out through the outlet channel 16a. This variant has the advantage that the moment in which the cartridge bottom 4b is pierced can be chosen independent of the closing operation of the brewing chamber and of the injection of brewing water into the cartridge. Otherwise, the alternative embodiment described herein before shows most of the previously named advantages.

The solution according to the invention can be realized in substantially all kinds of coffee makers. Particularly suitable are not only manual coffee makers with a manually insertable cartridge holder, but also semi-automatic coffee makers in which the cartridge is manually inserted into the cartridge receptacle and automatically removed as well as fully automatic coffee makers in which the cartridge is both automatically inserted into the cartridge receptacle and automatically removed there from. However, essential is that a certain relative axial movement between the cartridge received in the lower portion of the brewing chamber and the closure element takes place upon closing the brewing chamber, to ensure that, on the one hand, the cartridge cover is reliably pierced and, on the other hands, the cartridge bottom is at least partially weakened. Such relative movement usually has to amount to several millimeters and can be realized, for example, by means of a bayonet fixing, an eccentric drive mechanism, a lever mechanism, a spindle drive mechanism, a hydraulic drive mechanism or a slotted link mechanism.

1. Beverage machine for preparing a hot beverage by brewing and extracting a substance received in a cartridge having a cartridge cover and a cartridge bottom portion, comprising:
A brewing chamber adapted to receive said cartridge, comprising a lower brewing chamber portion and a closure element;
A pump for feeding brewing water under pressure into said brewing chamber;
At least one first piercing member adapted to pierce said cartridge cover;
At least one second piercing member adapted to pierce said cartridge bottom portion, said at least one second piercing member comprising at least one piercing tip portion and at least one outlet channel; and
Means for axially moving said lower brewing chamber portion relative to said closure element for closing said brewing chamber, the length of the path of said axial movement of said lower brewing chamber portion relative to said closure element being such that said cartridge cover is pierced by said first piercing element, while said at least one second piercing element penetrates or pierces said cartridge bottom at the most to such an extent that said outlet channel of said at least one second piercing element does not communicate with the interior of said cartridge.

2. Beverage machine for preparing a hot beverage by brewing and extracting a substance received in a cartridge having a cartridge cover and a cartridge bottom portion, comprising:
A brewing chamber adapted to receive said cartridge for brewing and extracting the substance contained in said cartridge, comprising a lower brewing chamber portion and a closure element;
A pump for feeding brewing water under pressure into said brewing chamber;
At least one first piercing member adapted to pierce said cartridge cover and attached to said closure element;
At least one second piercing member adapted to pierce said cartridge bottom portion and attached to or located in the region of said lower brewing chamber portion; and
Means for axially moving said at least one second piercing member attached to or located in the region of said lower brewing chamber portion relative to said lower brewing chamber portion to such an extent, after the brewing chamber having been closed by the closure member, that the bottom of said cartridge is pierced.

3. Beverage machine according to claim 1 in which said at least one first piercing member is attached to said closure element and said at least second piercing member is attached to said lower portion of said brewing chamber, whereby said outlet channel provided in said at least one second piercing member is located below and behind, respectively, said piercing tip of said at least one second piercing member, as seen in axial direction.

4. Beverage machine according to claim 3 in which, by injecting brewing water into the cartridge, said bottom of said cartridge is opened by means of said second piercing member located at the lower portion of the brewing chamber to such an extent that the outlet channel of said second piercing member communicates with the interior of said cartridge.

5. Beverage machine according to claim 3 in which said second piercing member located at the lower portion of the brewing chamber comprises a two-stage piercing portion, whereby a first stage is designed as a piercing tip and whereby the second stage is provided with at least one opening communicating with said outlet channel.

6. Beverage machine according to claim 3 in which said second piercing member located at the lower portion of the brewing chamber comprises a two-stage piercing portion, whereby the first stage is designed as a piercing tip and whereby the second stage is provided with essentially axially running outlet depressions, outlet channels or outlet grooves.

7. Beverage machine according to claim 5 in which said first stage of said second piercing member has conical shape and a smooth jacket surface.

8. Beverage machine according to claim 3 in which said lower portion of said brewing chamber is provided with a cartridge receptacle positively enclosing said cartridge, whereby the bottom of the cartridge is deformed by feeding pressurized water into the cartridge to such an extent that the outlet channel provided in said second piercing member is connected to the interior of said cartridge.

9. Beverage machine according to claim 3 in which said first piercing member is centrally attached to the closure member and said second piercing member is centrally attached to the lower portion of the brewing chamber, whereby both said first and second piercing members are provided with radial openings for feeding the brewing water and for dispensing the liquid beverage extract, respectively.

10. Beverage machine according to claim 3 in which said closure member is provided with a gasket member radially circumventing said first piercing member, said gasket member hydraulically sealing the cartridge cover relative to the cartridge bottom at the outer side of the cartridge upon closing said brewing chamber.

11. Beverage machine according to claim 3 in which said lower portion of said brewing chamber comprises a base portion and a cartridge receptacle supported on said base portion by means of springs, said cartridge receptacle being provided with a shoulder facing said closure member on which said closure member rests upon closing the brewing chamber and constituting, together with a flange member provided on the base portion, an axial stop member upon closing the brewing chamber.

12. Beverage machine according to claim 11 in which said second piercing member is attached to said base portion, whereby the bottom of the cartridge receptacle is provided with an opening whose location corresponds inasmuch with the location of the second piercing member that the second piercing member extends through said opening when the cartridge receptacle is pressed into said base portion upon closing the brewing chamber by said closure element against the force of said springs.

13. Beverage machine according to claim 3 in which said second piercing member located at the lower portion of the brewing chamber or the, conduit connected to said second piercing member is provided with a pressure control valve.

14. Beverage machine according to claim 2 in which the bottom of the cartridge, after the start of feeding brewing water into the cartridge, is pierced by the piercing member located at the lower portion of the brewing chamber or in the region of the lower portion of the brewing chamber to such an extent that the liquid extract can flow out of the cartridge through the piercing member or through an outlet channel provided in the piercing member.

15. Beverage machine according to claim 14 in which said closure member is provided with a gasket member radially circumventing said first piercing member, said gasket member hydraulically sealing the cartridge cover relative to the cartridge bottom at the outer side of the cartridge upon closing said brewing chamber.

16. Beverage machine according to claim 14 in which said second piercing member is attached to said base portion, whereby the bottom of the cartridge receptacle is provided with an opening whose location corresponds inasmuch with the location of the second piercing member that the second piercing member extends through said opening when the cartridge receptacle is pressed into said base portion upon closing the brewing chamber by said closure element against the force of said springs.

17. Beverage machine according to claim 16 in which said second piercing member is attached to said base portion, whereby the bottom of the cartridge receptacle is provided with an opening whose location corresponds inasmuch with the location of the second piercing member that the second piercing member extends through said opening when the cartridge receptacle is pressed into said base portion upon closing the brewing chamber by said closure element against the force of said springs.

18. Beverage machine according to claim 14 in which said second piercing member located at the lower portion of the brewing chamber or the conduit connected to said second piercing member is provided with a pressure control valve.

19. Cartridge adapted to be used in a beverage machine according to one of the preceding claims, comprising:
An essentially cup-shaped cartridge body and a cartridge cover attached to said cartridge body, said cartridge containing a predetermined amount of a substance extractable by means of hot water; and
A sieve-like member located between the bottom of said cartridge body and said substance contained in said cartridge, said sieve-like member having a central recess directed towards the interior of the cartridge and dimensioned such that the front portion of a piercing member adapted to pierce said bottom of said cartridge body can extend into said recess, once the cartridge bottom has been pierced, without piercing said sieve-like member.

20. Cartridge adapted to be used in a beverage machine according to one of the preceding claims, comprising:
An essentially cup-shaped cartridge body and a cartridge cover attached to said cartridge body, said cartridge containing a predetermined amount of a substance extractable by means of hot water;
A first sieve-like member located between the bottom of said cartridge body and said substance contained in said cartridge, said first sieve-like member having a central recess directed towards the interior of the cartridge and dimensioned such that the front portion of a piercing member adapted to pierce said bottom of said cartridge body can extend into said recess, once the cartridge bottom has been pierced, without piercing said first sieve-like member; and
A second sieve-like member located between the cover of said cartridge body and said substance contained in said cartridge, said second sieve-like member having a central recess directed towards the interior of the cartridge and dimensioned such that the front portion of a piercing member adapted to pierce said cover of said cartridge can extend into said recess, once the cartridge cover has been pierced, without piercing said second sieve-like member.

21. Cartridge according to claim 19 in which a free space or fluid channels are provided between said sieve-like member and the bottom of said cartridge body in which the liquid extract is collected.

22. Cartridge according to claim 20 in which a free space or fluid channels are provided between said first sieve-like member and the bottom of said cartridge body in which the liquid extract is collected, and in which a free space or fluid channels are provided between said second sieve-like member and the cover of said cartridge in which the brewing water is distributed over the cross section of the cartridge.

23. Cartridge according to claim 19 in which the bottom of said cartridge is bossed.

24. Cartridge according to claim 19 in which said cartridge cover has a lower ductility and/or tear strength than the bottom of said cartridge.

25. Cartridge according to claim 19 in which said bottom of the cartridge is dimensioned such that at least the piercing tip of the piercing member penetrates the cartridge bottom once the brewing chamber is closed.

26. A method of preparing a hot beverage by brewing and extracting a substance received in a cartridge, the method comprising the steps of:
Providing a brewing chamber adapted for receiving the cartridge and having a first piercing member incorporating a brewing water feed channel and a second piercing member incorporating a beverage outlet channel;
Enclosing the cartridge in said brewing chamber and piercing a first side of the cartridge by means of said first piercing member;
Partially weakening the opposite side of the cartridge by means of said second piercing member; and
Feeding brewing water through said brewing water feed channel of said first piercing member into the interior of the cartridge to create a hydraulic overpressure in the interior of the cartridge, thereby expanding the cartridge such that it is pierced by said second piercing member at said mechanically weakened side to connect the interior of the cartridge to said beverage outlet channel in said second piercing member.

27. A method of preparing a hot beverage by brewing and extracting a substance received in a cartridge, the method comprising the steps of:
Providing a brewing chamber adapted for receiving the cartridge and having a first piercing member incorporating a brewing water feed channel and a second piercing member incorporating a beverage outlet channel;
Enclosing the cartridge in said brewing chamber and piercing a first side of the cartridge by means of said first piercing member;
Partially piercing the cartridge at the opposite side of the cartridge by means of said second piercing member to such an extent that said outlet channel of said second piercing element is not yet connected to the interior of the cartridge; and
Feeding brewing water through said brewing water feed channel of said first piercing member into the interior of the cartridge to create a hydraulic overpressure in the interior of the cartridge, thereby expanding the cartridge such that it is fully pierced by said second piercing member at said opposite side to connect the interior of the cartridge to said beverage outlet channel in said second piercing member.

28. A method of preparing a hot beverage by brewing and extracting a substance received in a cartridge, the method comprising the steps of:
Providing a brewing chamber adapted for receiving the cartridge and having a first piercing member incorporating a brewing water feed channel and a second piercing member incorporating a beverage outlet channel;
Enclosing the cartridge in said brewing chamber and piercing a first side of the cartridge by means of said first piercing member;
Feeding brewing water through said brewing water feed channel of said first piercing member into the interior of the cartridge to create a hydraulic overpressure in the interior of the cartridge; and
Piercing the cartridge by means of said second piercing member at said opposite side to connect the interior of the cartridge to said beverage outlet channel in said second piercing member.

29. Beverage machine according to claim 6 in which said first stage of said second piercing member has conical shape and a smooth jacket surface.

30. Cartridge according to claim 20 in which the bottom of said cartridge is bossed.

31. Cartridge according to claim 20 in which said cartridge cover has a lower ductility and/or tear strength than the bottom of said cartridge.

32. Cartridge according to claim 20 in which said bottom of the cartridge is dimensioned such that at least the piercing tip of the piercing member penetrates the cartridge bottom once the brewing chamber is closed.
